(19) United States
(12) Patent Application Publication
(10) Pub. No.: US 2013/0327890 A1
(43) Pub. Date: Dec. 12, 2013

(54) BUOYANCY SYSTEM

(71) Applicant: Tim Lyons, Shoalwater (AU)

(72) Inventor: Tim Lyons, Shoalwater (AU)

(21) Appl. No.: 14/001,238

(22) PCT Filed: Feb. 27, 2012
(86) PCT No.: PCT/AU12/00192

§ 371 Date: Aug. 23, 2013

(30) Foreign Application Priority Data
Feb. 25, 2011 (AU) 2011900642

(51) Int. Cl. B64C 25/56

(52) U.S. Cl. CPC B64C 25/56
USPC 244/107

(57) ABSTRACT

The present invention provides an aircraft buoyancy system (14) for providing positive buoyancy to an aircraft (15) to keep it afloat at the surface of a body of water (16) after crashing, ditching or landing into a body of water (16). The aircraft buoyancy system (14) comprises at least one inflatable body (1) which, when inflated, increases the buoyancy of the aircraft (14), and a gas generation system (4) to inflate the at least one inflatable body (1). The aircraft buoyancy system (14) also comprises a sensor and activation system (3) to activate the gas generation system (4). Upon activation of the sensor and activation system (3) the gas generation system (4) causes a gas to flow to the at least one inflatable body (1), causing the aircraft (15) to float and remain at the surface of a body of water (16).

### FIELD OF THE INVENTION

The present invention generally relates to a buoyancy system for keeping aircraft afloat. In particular, the present invention provides a buoyancy system for keeping an aircraft upright, upon landing, crashing or ditching into a body of water.

### BACKGROUND ART

There are inherent difficulties and limitations associated with current in-built buoyancy/floatation systems fitted to aircraft, which are typically permanently attached to the aircraft. Permanently fitted buoyancy/floatation systems add significant weight to the airframe, increasing fuel consumption, maintenance hours and additional cost whilst reducing endurance, payload and the overall capability of the aircraft. For these reasons, incorporating permanent buoyancy/floatation systems into multi role aircraft is often deemed not feasible. Hence many multi role aircraft do not have emergency buoyancy/floatation systems fitted.

Multi role aircraft such as military Blackhawk helicopters are often employed by Defence Forces to perform operations over water. In most cases such aircraft are not fitted with a system that can provide sufficient buoyancy to keep the aircraft afloat, which is a problem should they ditch or crash into water. History continues to demonstrate that aircraft generally sink very quickly once they ditch or crash into water. This poses a significant risk to the aircraft and their crew when operating over water.

Buoyancy and floatation systems currently fitted to marine helicopters are generally heavy in weight, reducing the aircraft's capability and performance.

Additionally, in most helicopters the inflatable buoyancy bags are positioned to inflate low on the airframe. As most helicopters have a high centre of gravity due to the positioning of the engine(s), transmission and rotor hub, the inflated inflatable buoyancy bags, tend to cause the aircraft to overturn and sit upside down in the water, presenting disorientation problems to the submerged crew and passengers, and increasing the difficulty to rescue the crew and passengers.

The preceding discussion of the background to the invention is intended only to facilitate an understanding of the present invention. It should be appreciated that the discussion is not an acknowledgment or admission that any of the material referred to was part of the common general knowledge as at the priority date of the application.

### SUMMARY OF INVENTION

The buoyancy system of the present invention provides a light weight emergency floatation solution for aircraft operating over a body of water. The primary objective of the buoyancy system is to provide sufficient time for aircraft occupants to safely egress an aircraft after an event that has lead to the aircraft landing, crashing or ditching into a body of water. A secondary objective of the buoyancy system is to assist in the recovery of the aircraft including the recovery of any cryptographic, weapons, sensitive or other valuable materials, and to assist subsequent aircraft investigation.

The present invention provides a buoyancy system adapted to be fitted to an aircraft for keeping the aircraft of and upright, upon landing, crashing or ditching into a body of water, the system comprises:

at least one inflatable body which, when inflated, increases the buoyancy of the aircraft;

an inflation apparatus to inflate the at least one inflatable body;

an activation system to activate the inflation apparatus where upon meeting activation criteria or upon manual activation, the activation system will activate the inflation apparatus causing a gas to flow to the at least one inflatable body, which once inflated to the required volume enables the aircraft to remain positively buoyant at the surface of a body of water;

a deployment means, such that in operation the deployment means restricts the inflation of the at least one inflatable body until the at least one inflatable body can be inflated without being damaged by moving parts of the aircraft.

Preferably, the at least one inflatable body is adapted to be positioned on the aircraft such that once inflated the positioning of the at least one inflatable body ensures the aircraft is maintained in an upright position. This assumes that the main portion of the aircraft remains largely intact and/or the at least one inflatable body remains secured to the aircraft. Obviously if the centre of gravity changes significantly as a result of the crash, or the at least one inflatable body is no longer secured to the aircraft then the weight distribution changes significantly, resulting in different buoyancy requirements.

In contrast to the prior art, the deployment means of the present invention enables the at least one inflatable body to be positioned closer to the centre of gravity of the aircraft once inflated. As a result, when the at least one inflatable body inflates, the positioning of the at least one inflatable body causes the helicopter to be maintained afloat in an upright position, wherein the cabin of the aircraft is located above the aircrafts undercarriage or is otherwise orientated such that the surface of the water is directly above the cabin, preventing disorientation of the air crew and passengers. The deployment means ensures that the at least one inflatable body does not inflate until such time as those moving parts of the aircraft which are in the vicinity of the at least one inflatable body can no longer damage the inflatable body. In those cases in which the aircraft is a helicopter, the deployment device ensures the at least one inflatable body does not inflate until such time as the blades of the helicopter have detached from the helicopter, or have stopped rotating.

Preferably the at least one inflatable body will inflate into a position that will keep the aircraft upright at the surface of a body of water.

In one application the aircraft is a helicopter, wherein when fitted, the inflated at least one inflatable body is in proximity to the engine. This counters a high centre of gravity in helicopter aircraft.

In a deflated condition, the at least one inflatable body may be stored at any position on the aircraft. Preferably the at least one inflatable body is stored in proximity to the position the at least one inflatable body is required when inflated.

Preferably the deployment means is in the form of a time delay device whereby the at least one inflatable body inflates after a prescribed period of time following manual activation of the activation system or after a prescribed period of time following the activation criteria being meat. Preferably the deployment means is incorporated in the activation system.

Preferably the at least one inflatable body incorporates internal walls and one way valves to reduce the effects of punctures that may result from damaged areas of the aircraft which may be caused when the aircraft crashes or ditches into a body of water.

In many applications the inflated inflatable body will contact with the body of the aircraft adjacent the engine, in order to keep the aircraft in an upright position. Preferably the at least one inflatable body is made from a material having high heat resistance properties.

Once inflated the inflatable body may remain inflated for a predetermined period of time, generally until the, aircraft is recovered.

Preferably the at least one inflatable body is made from a gas tight material. This will ensure the gas is held in the inflatable body for a long period of time ensuring there is ample time to rescue the crew, and preferably the aircraft.

Preferably the at least one inflatable body is made from a light weight, high tensile strength material. This will reduce the weight of the buoyancy system.

Preferably the buoyancy system comprises a plurality of inflatable bodies.

The at least one inflatable body may also comprise a one way valve between the inflation apparatus and an opening into the inflatable body. This will prevent the gas delivered into the inflatable body returning to the inflation apparatus.

The at least one inflatable body may comprise at least one pressure relief valve to release excess gas from the inflatable body. The requirement to release excess gas may be as a result of excess gas generated by the inflation apparatus.

Preferably the buoyancy system comprises an inflation apparatus for each inflatable body.

Preferably upon inflation each inflatable body inflates external of the aircraft.

The inflation apparatus may comprise a regulatory apparatus to regulate the amount of gas passing into the at least one inflatable body. Preferably the gas regulator delivers gas to the at least one inflatable body at the desired pressure.

The inflation apparatus may comprise a gas generation system, or a gas storage system, or a combination of these systems.

The gas generation system may comprise a gas generating medium such as for example an explosive, propellant or other chemical compound whereby a charge activates the medium, creating a gas.

Preferably the gas generated from the medium is cooled prior to being delivered to the at least one inflatable body.

The gas storage system may comprise a gas storage cylinder containing the gas. Preferably the gas storage cylinder is in fluid communication with the at least one inflatable body through an outlet passage.

Preferably the gas storage cylinders are light weight. The cylinders may be a carbon fibre composite material. Preferably the molecular weight of the generated gas is less than that of air.

The inflation apparatus may comprise at least one hydrostatic sensor or pressure relief valve which is adapted to discontinue the delivery of gas to the at least one inflatable body once ascent has commenced when activation occurs after the aircraft is submerged. Once the ascent has commenced the inflatable body will continue to inflate even if there was no more gas being provided to the inflatable body as the gas inside the inflatable body expands with the reduction in external pressure.

The activation system may comprise a plurality of sensors. Each sensor may be adapted to detect different parameters. Preferably the activation system comprises a combination of sensors and may include hydrostatic, water, altimeter or shock or impact sensors.

The activation system may be activated in a variety of ways, largely dictated by the type of aircraft and its roles and functions in the marine environment. This is particularly important to ensure that the buoyancy system can be activated regardless of the situation.

The activation system may activate automatically when the aircraft enters a body of water. Preferably a sensor detects when the aircraft is partially or wholly submerged, whereupon the activation system activates the inflation apparatus.

The activation system may be hydrostatically activated when the aircraft reaches a predetermined depth. Preferably a sensor detects when the aircraft reaches a certain depth, whereupon the activation system activates the inflation apparatus. The sensor may comprise one or more hydrostatically operated devices or other automatic activation sensors fitted to the buoyancy system.

The activation system may be water activated when sensors come into contact with excessive water. The automatic activation mechanism may comprise one or more water activated sensor devices or other automatic activation sensors fitted to the buoyancy system.

The activation system may be activated when the aircraft's rate of decent exceeds a predetermined limit. Preferably one or more altimeter sensors detect when the aircraft's rate of decent exceeds a predetermined limit, whereupon the activation system activates the inflation apparatus. The deployment means may delay the inflation of the at least one body to ensure the at least one body does not inflate until the aircraft is in the water.

The activation system may be activated when the aircraft impacts with a body of water. Preferably one or more impact sensors detect when the aircraft impacts a body of water resulting, whereupon the activation system activates the inflation apparatus.

The activation system may be manually operated from within the aircraft. The manual activation system maybe wired directly from the aircraft's cockpit to the buoyancy system. The manual activation system maybe controlled remotely with a manual activation remote control placed in the aircraft's cockpit when the buoyancy system is fitted.

The buoyancy system may have a release means so that it can be detached/jettisoned from the aircraft. The release means may be operated if the buoyancy system is unintentionally activated.

Preferably the buoyancy system may be easily attached and detached from the aircraft. As the buoyancy system is only required for aircraft flying over large bodies of water, it is desirable to be able to easily attach and detach the buoyancy system to the aircraft to suit the aircrafts mission. In contrast to the prior art, the buoyancy system of this invention is configured to allow a technician to easily attach or detach the buoyancy system, as opposed to being permanently fixed to the aircraft. The present invention is also configured so that it may be attached or detached on the base, or in the field.

Preferably the buoyancy system is secured to the aircraft's airframe. In order to secure the buoyancy system to an aircraft, the aircraft's airframe may need to be modified prior to installation.

The buoyancy system may be powered by its own independent power source or from a power source within the aircraft, or a combination of both.

Preferably the buoyancy system, when in the stored condition, does not substantially affect the flying characteristics or aerodynamics of the aircraft.

Preferably the buoyancy system can be disarmed to ensure accidental activation does not occur whilst maintenance staff are working on the aircraft which it is fitted to or whilst the buoyancy system is in storage. For example, a tagged disarming pin which can be inserted in the buoyancy system when the system and/or aircraft that it is fitted to is not in use, and quickly removed prior to flying the aircraft to re-arm the buoyancy system.

This invention provides the next generation in emergency aircraft buoyancy and floatation. This new generation of emergency aircraft buoyancy and floatation provides a means of reducing the overall weight of the aircraft when flying over water and land whilst also providing a capability to keep the aircraft afloat should it crash or ditch into a body of water allowing aircraft occupants to escape at the surface and further allowing the aircraft to be recovered. The present invention provides a buoyancy system for keeping an aircraft afloat, and in most cases upright, upon landing, crashing or ditching into a body of water, the system comprises:

at least one inflatable body which, when inflated, increases the buoyancy of the aircraft;

an inflation apparatus to inflate the at least one inflatable body;

a sensor and activation system to activate the inflation apparatus;

where upon meeting activation criteria or upon manual activation, the sensor and activation system will activate the inflation apparatus causing a gas to flow to the at least one inflatable body, which once inflated to the required volume enables the aircraft to remain positively buoyant at the surface of a body of water.

The present invention provides a buoyancy system adapted to be fitted to a helicopter for keeping the helicopter afloat and upright, upon landing, crashing or ditching into a body of water, the system comprises:

at least one inflatable body which, when inflated, increases the buoyancy of the helicopter, the at least one inflatable body being positioned on the helicopter such that once inflated the helicopter is maintained in an upright position, once inflated the at least one inflatable body being in proximity to the centre of gravity of the helicopter;

an inflation apparatus to inflate the at least one inflatable body;

a sensor and activation system to activate the inflation apparatus where upon meeting activation criteria or upon manual activation, the sensor and activation system will activate the inflation apparatus causing a gas to flow to the at least one inflatable body, which once inflated to the required volume enables the helicopter to remain positively buoyant at the surface of a body of water;

a deployment device, the deployment device restricting the inflation of the at least one inflatable body until the blades of the helicopter have detached from the helicopter or otherwise stopped rotating.

The present invention provides an aircraft having at least one buoyancy system as substantially herein described secured thereto.

The aircraft may be fitted with more than one buoyancy system.

### BRIEF DESCRIPTION OF THE DRAWINGS

The invention will be better understood by reference to the following description of several specific embodiments thereof as shown in the accompanying drawings in which:

FIGS. 1 a, b, c are side, plan and front views of a helicopter (Tiger ARH) having a buoyancy system according to a first embodiment of the invention installed under each snub wing;

FIGS. 2 a, b, c are similar views to FIGS. 1 a, b, c but with the buoyancy system deployed;

FIG. 3 is a schematic layout of the buoyancy system of the first embodiment;

FIG. 4 is a schematic layout of an at least one inflatable body within the buoyancy system;

FIG. 5 a is a view of a helicopter (Tiger ARH) post ditching floating on the surface of a body of water with the buoyancy system activated;

FIGS. 6 a, b are side and plan views of a buoyancy system according to a second embodiment of the invention wherein the inflatable body is inflated;

FIGS. 7 a, b are side and bottom views of a buoyancy system according to a third embodiment of the invention wherein the inflatable body is inflated;

FIG. 8a is a view of a helicopter (Tiger ARH) with a buoyancy system fitted;

FIG. 8b is a view of the helicopter (Tiger ARH) in FIG. 8a in water in an upright orientation with the inflatable body deployed;

FIG. 9a is a view of the helicopter (Tiger ARH) in FIG. 9a in water in an upright orientation with the inflatable bodies deployed;

FIGS. 10 a, b is a view of a helicopter (MRH 90) with multiple inbuilt and/or semi permanent buoyancy systems fitted; and

FIG. 10 c the helicopter (MRH 90) in FIG. 10a in water in an upright orientation with the inflatable bodies deployed;

### BEST MODE(S) FOR CARRYING OUT THE INVENTION

The present invention has many applications across numerous aircraft and provides significant advantages over the prior art.

The below embodiments discuss applications in which a helicopter ditches or crashes into a body of water. However, it is to be understood that the present invention may be fitted to other type of aircraft, those applications being covered by the present invention.

The invention according to the various embodiments is in the form of a buoyancy system 14 fitted to an helicopter 16 whereby, post activation, the buoyancy system 14 will keep the helicopter 15 afloat and maintain it in a substantially upright orientation near the surface of a body of water 16.

The buoyancy system 14 may quickly be removed from and easily attach to an helicopter 15, depending on whether the helicopter 15 will be flying over water. This ensures the weight of the helicopter can be optimised when flying over land where a buoyancy system is not required.

The buoyancy system 14 comprises a combination of one or more inflatable bodies 1, one or more gas generation systems 4, one or more sensor and activation systems 3, and one or more deployment means. In different applications and circumstances the buoyancy system 14 is configured to incorporate the required quantity and configuration of the aforementioned components.

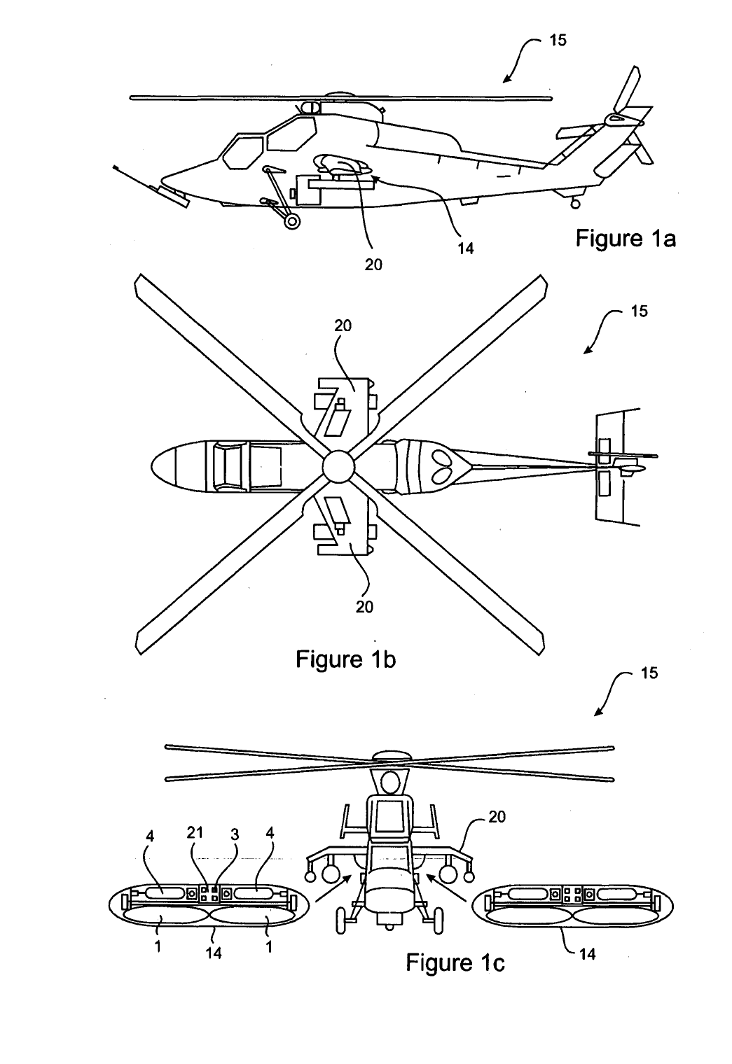

Referring to FIGS. 1 to 5, the invention according to a first embodiment is in the form of a buoyancy system 14 fitted underneath each snub wing 20 of a helicopter 15.

FIGS. 1 a, b, c show the helicopter 15 fitted with two buoyancy systems 14, whereby each buoyancy system 14 is in a stored condition, i.e. ready for activation.

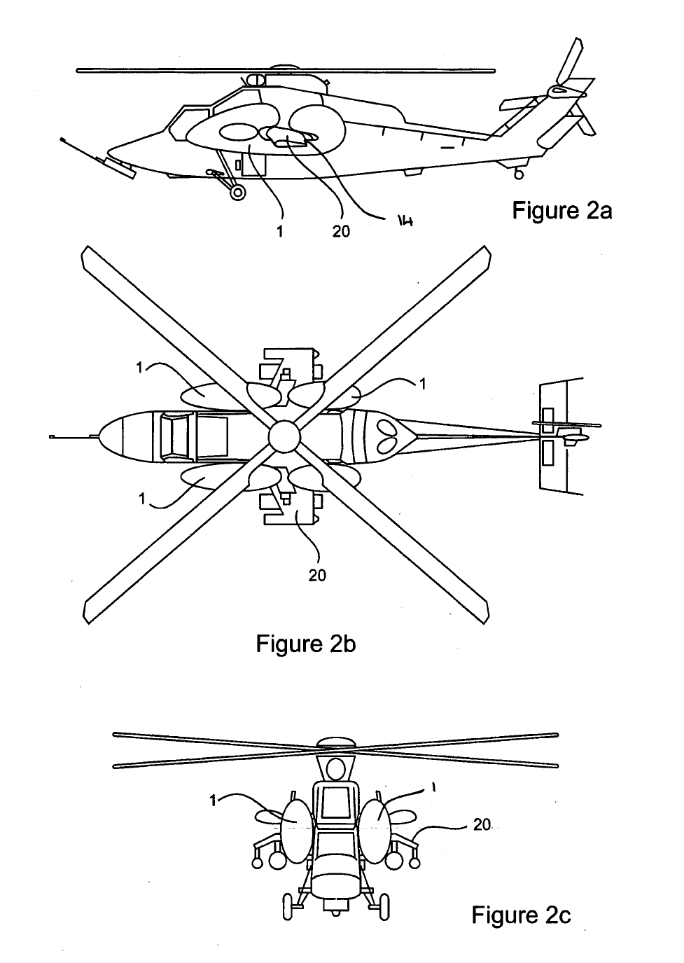

FIGS. 2 a, b, c shows the buoyancy systems 14 after each buoyancy system has been activated and each inflatable body 1 has been deployed.

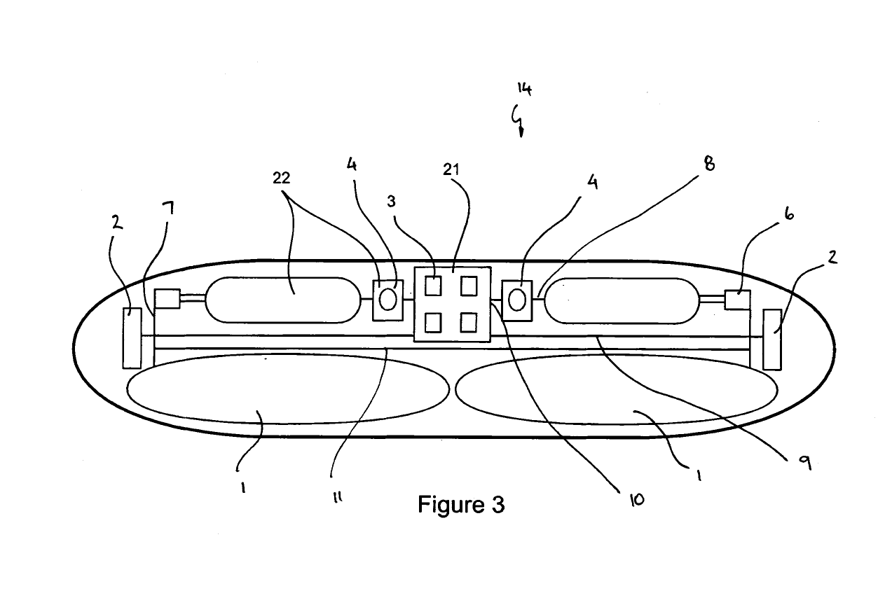

The components of each buoyancy system 14 according to this embodiment are best shown in FIG. 3. Each buoyancy system 14 comprises an inflation apparatus 22, which in this embodiment, is provided by two active gas generation systems 4.

Each gas generation system 4 is activated by an activation system 3. Upon activation, each gas generation system 4 generates a gas, which flows into and inflates each inflatable body 1.

The activation system 3 also comprises a plurality of sensors 21 which sense changes in various parameters affecting the helicopter 15. The sensors 21 in this embodiment include hydrostatic, impact, water and altimeter sensors which, upon sensing a change in the parameter they are monitoring, automatically activate the activation system 3. Some applications of the buoyancy system may only require one or a combination of these sensors and activation mediums.

The buoyancy system 14 also incorporates a hard wire and/or remote control mechanism (not shown) for manual activation of the activation system 3 should it be required.

Power is supplied to the activation system 3 from a power supply 2 through electrical wiring 9.

In operation, when one or more of the sensors 21 meet predetermined activation criteria, such as being submerged in water, the activation system 3 activates, providing an electrical charge to the gas generation system 4 through electrical wire 9. This electrical charge causes the gas generation system 4 to produce/supply a gas. The gas is supplied directly through a gas regulator 6. The gas is provided to the inflatable body 1 from the gas regulator 6 through pneumatic hose 7. Pneumatic hose 7 also incorporates a one way valve 18 to prevent the gas delivered into the inflatable body 1 from returning through the gas regulator 6.

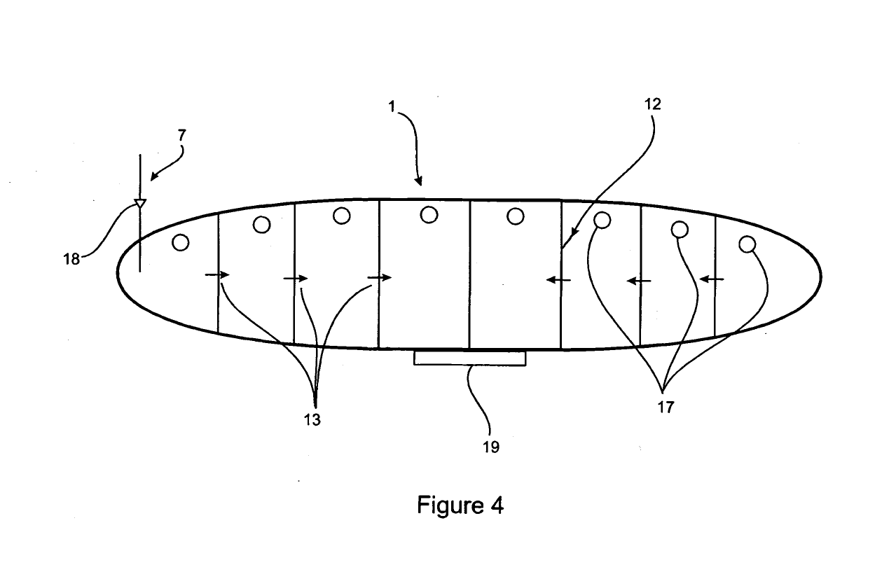

An inflated inflatable body 1 is shown in FIG. 4. The inflatable body 1 comprises internal walls 12, one-way flow valves 13, and pressure relief valves 17. In some applications of the invention, pressure relief valve 17 may lock, preventing any further gas from passing therethrough to ensure the inflatable body 1 remains inflated, such as may be the case when the inflatable body is on the surface of the water. In use, should the inflatable body 1 be punctured, the configuration of the inflatable body 1, ensures the unaffected part of the inflatable body 1 remains inflated such that the inflatable body 1 can still contribute to the buoyancy of the aircraft.

Each inflatable body 1 may also incorporate an EPIRB 19 which is activated when the inflatable body 1 is inflated.

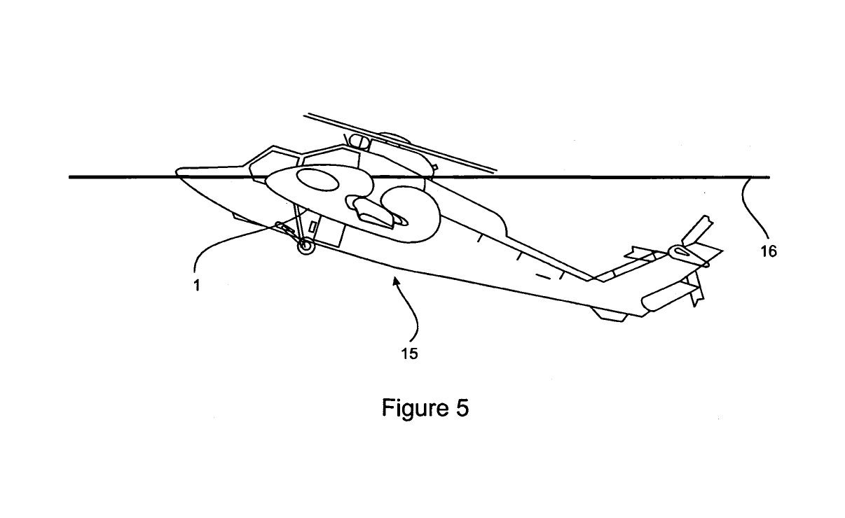

FIG. 5 illustrates how the inflatable bodies 1 are positioned to ensure that the helicopter 15 remains upright and afloat on the surface of a body of water 16 once it has crashed into the water.

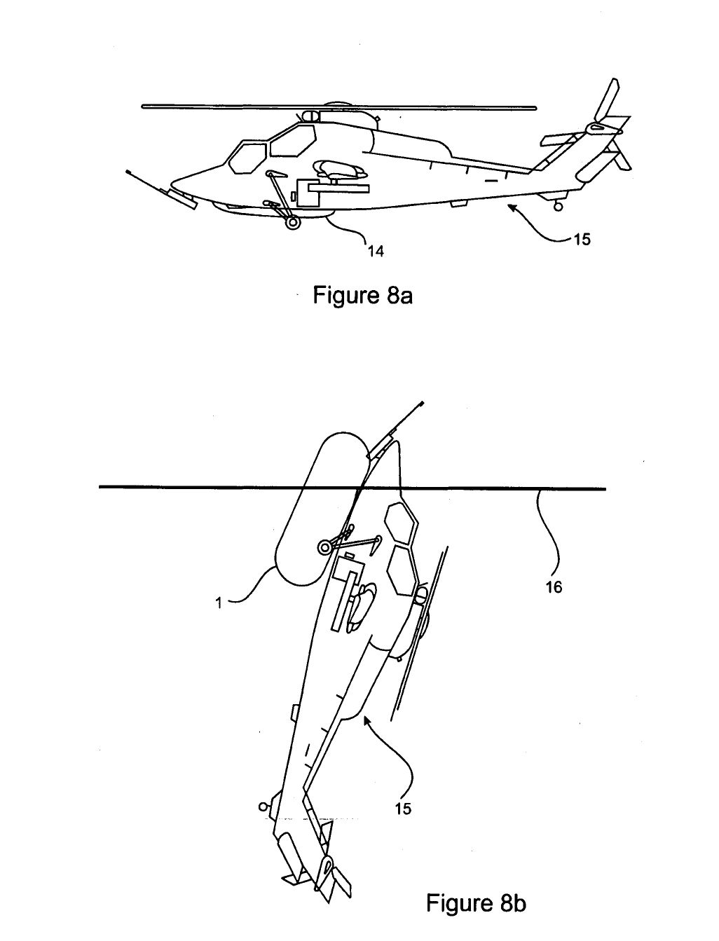

FIGS. 8a, b show a similar helicopter 15 as that shown in FIG. 5, but with only one buoyancy system 14 having only one inflatable body 1 secured under the cock pit of the helicopter in a forward position. As shown in FIG. 8b, the forward position of the buoyancy system 14 maintains the helicopter 15 in an upright position whereby the crew members and passengers are still able to escape without being disorientated.

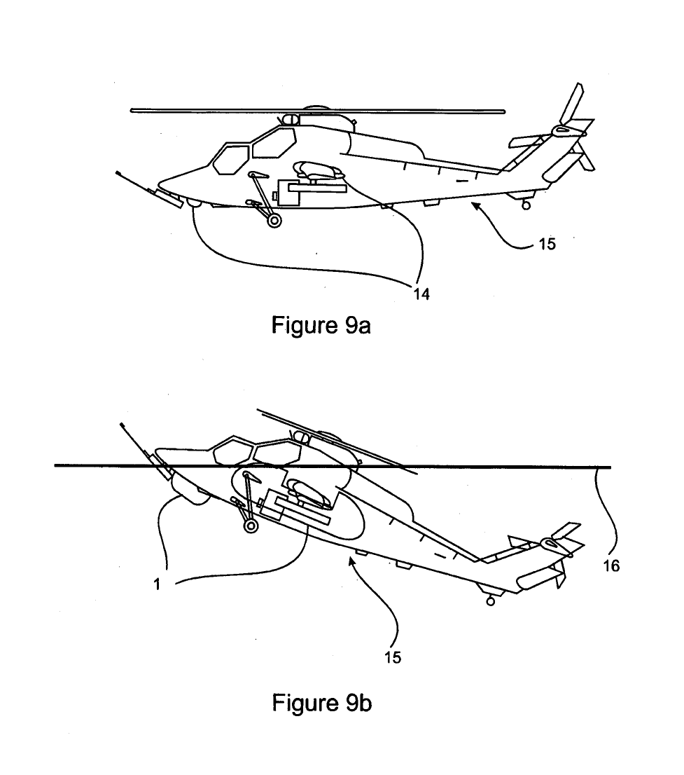

FIGS. 9 a, b show a similar helicopter 15 as that shown in FIG. 5, whereby there is an additional buoyancy system 14 underneath the forward end of the helicopter.

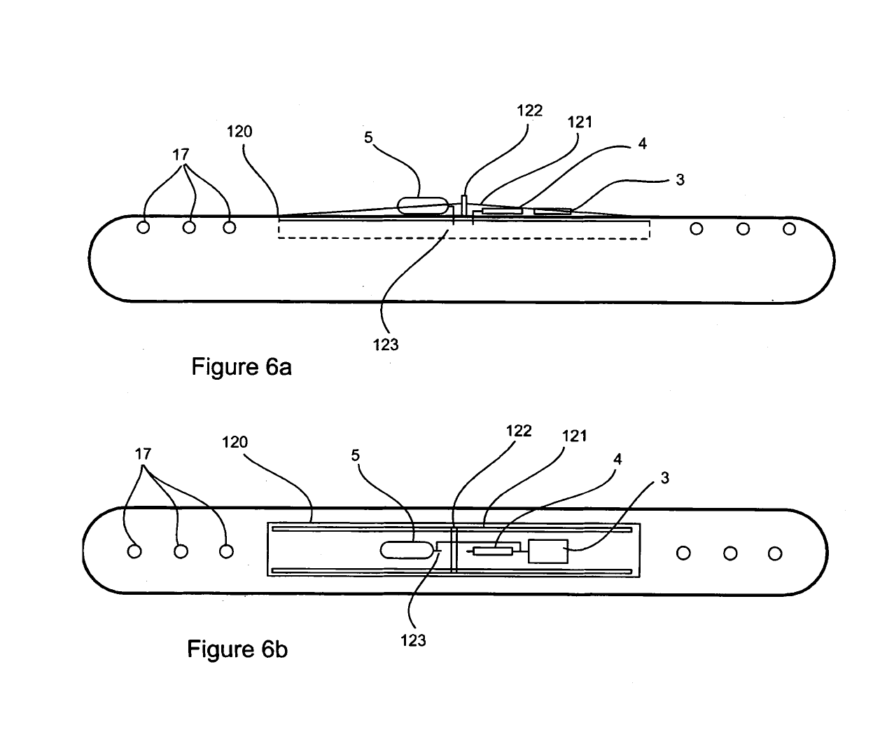

A second embodiment of the buoyancy system 14 is shown in FIGS. 6a, b in which the inflatable body 1 is in an inflated condition. For convenience features of the second embodiment that are similar or correspond to features of the buoyancy system of the first embodiment have been referenced with the same reference numerals. The buoyancy system 14 in this embodiment is secured to a frame 120 to which the components of the buoyancy system 14 are secured. The frame 120 also comprises a mounting point 122 which is adapted to removably secure the buoyancy system 14 to a helicopter 15 in a manner whereby the buoyancy system may be quickly attached and detached to the helicopter.

The operation of this system is also similar to that described in FIG. 1. The only difference is that the gas generated by the gas generation system 4 is first delivered to a gas reservoir 5 prior to delivery to the gas regulator 6. This allows more control of the gas into the inflatable body 1.

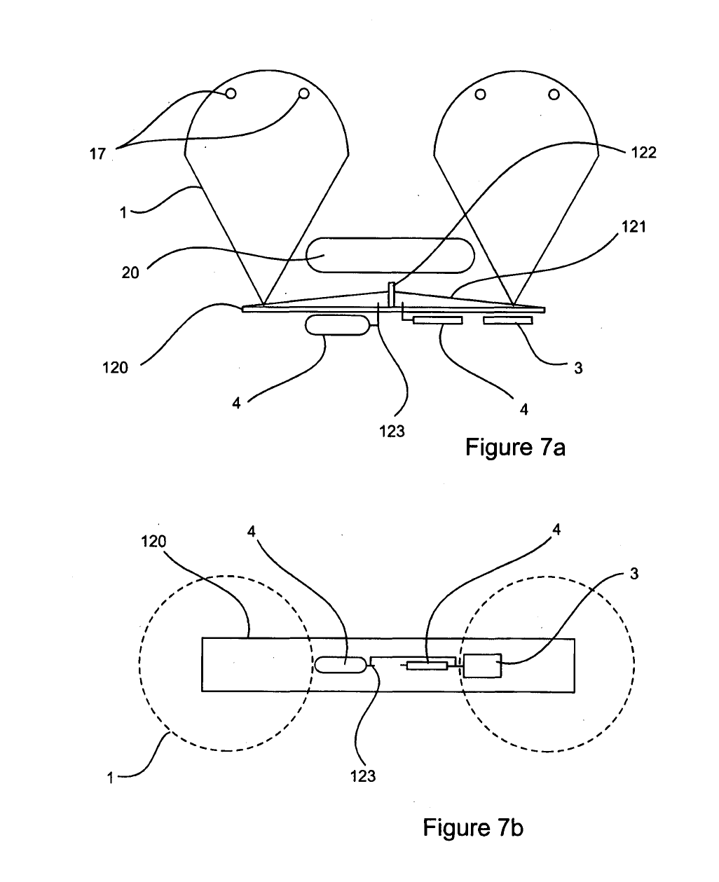

A third embodiment of the buoyancy system 14 is shown in FIGS. 7a, b in which two inflatable bodies 1 are in an inflated condition. For convenience features of the third embodiment that are similar or correspond to features of the buoyancy system of the second embodiment have been referenced with the same reference numerals. The buoyancy system 14 in this embodiment is secured to a frame 120 to which the components of the buoyancy system 14 are secured. The frame 120 also comprises a mounting point 122 which is adapted to removably secure the buoyancy system 14 underneath snub wings 20 of to a helicopter 15 in a manner whereby the buoyancy system may be quickly attached and detached to the helicopter.

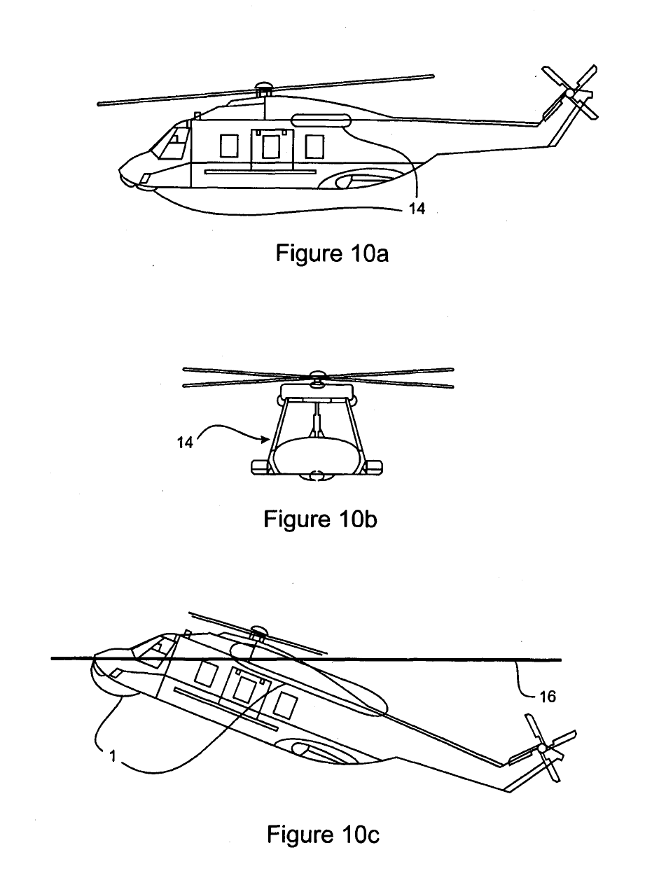

FIGS. 10 a, b, c show three buoyancy systems 14 secured to a larger helicopter 15. The buoyancy system 14, when in the stored condition (FIGS. 10 a, b) remain largely within the profile of the helicopter such that there is minimal impact on the helicopters aerodynamics.

As identified in the above embodiments, this invention provides a light weight solution for maintaining an aircraft at or near the surface of a body of water, and has the ability to be easily attached or detached from an aircraft.

Modifications and variations such as would be apparent to the skilled addressee are considered to fall within the scope of the present invention. For instance, the gas may be replaced by a foam like substance which may expand and harden once expelled into the at least one inflatable body.

Throughout the specification, unless the context requires otherwise, the word “comprise” or variations such as “comprises” or “comprising”, will be understood to imply the inclusion of a stated integer or group of integers but not the exclusion of any other integer or group of integers.

1-39. (canceled)

40. A buoyancy system adapted to be fitted to an aircraft for keeping the aircraft afloat after crashing or ditching into a body of water, the system comprises:
at least one inflatable body which, when inflated, increases the buoyancy of the aircraft;
an inflation apparatus to inflate the at least one inflatable body, the inflation apparatus comprises a gas generation system, wherein the gas generation system comprises a gas generating medium to produce a gas to inflate the at least one inflatable body;
an activation system to activate the inflation apparatus where upon meeting crash activation criteria, the activation system will activate the inflation apparatus causing the gas to flow to the at least one inflatable body, which once inflated to the required volume enables the aircraft to remain positively buoyant at the surface of a body of water;
a deployment means, such that in operation the deployment means restricts the inflation of the at least one inflatable body until the at least one inflatable body can be inflated without being damaged by moving parts of the aircraft.

41. The buoyancy system according to claim 40 wherein the at least one inflatable body will inflate into a position that will keep the aircraft in a favourable orientation for escape at the surface of a body of water.

42. The buoyancy system according to claim 40 wherein the aircraft is a helicopter, wherein when fitted, the inflated at least one inflatable body is in proximity to the engine.

43. The buoyancy system according to claim 40 wherein the deployment means is in the form of a time delay device, the deployment means preventing the at least one inflatable body from inflating until after a prescribed period of time or prescribed depth is achieved following activation of the activation system when the activation criteria is met.

44. The buoyancy system according to claim 40 wherein the deployment means is incorporated in the activation system.

45. The buoyancy system according to claim 40 wherein the at least one inflatable body incorporates internal walls and one way valves.

46. The buoyancy system according to claim 40 wherein the at least one inflatable body is made from a gas tight material having high heat resistance properties.

47. The buoyancy system according to claim 40 wherein the at least one inflatable body also comprise a one way valve between the inflation apparatus and an opening into the inflatable body.

48. The buoyancy system according to claim 40 wherein the at least one inflatable body comprise at least one pressure relief valve to release excess gas from the inflatable body.

49. The buoyancy system according to claim 40 wherein the aircraft buoyancy system comprises an inflation apparatus for each inflatable body.

50. The buoyancy system according to claim 40 wherein the inflation apparatus comprise a regulatory apparatus to regulate the amount of gas passing into the at least one inflatable body, the gas regulator delivering gas to the at least one inflatable body at the desired pressure.

51. The buoyancy system according to claim 40 wherein the gas generating medium is in the form of an explosive, propellant or other chemical compound whereby a charge activates the medium, creating the gas.

52. The buoyancy system according to claim 40 wherein the inflation apparatus may also comprise a gas storage system, the gas storage system comprises a gas storage cylinder containing the gas, the gas storage cylinder being in fluid communication with the at least one inflatable body through an outlet passage.

53. The buoyancy system according to claim 40 wherein the inflation apparatus comprise at least one hydrostatic sensor or pressure relief valve which is adapted to discontinue the delivery of gas to the at least one inflatable body once ascent has commenced when activation occurs after the aircraft is submerged.

54. The buoyancy system according to claim 40 wherein the activation system is triggered by one or more of a plurality of different sensors for sensing different conditions, the sensors detect one or more of the following criteria:
when the aircraft is partially or wholly submerged;
when the aircraft reaches a certain depth;
when the aircraft's rate of decent exceeds a predetermined limit;
when the aircraft impacts a body of water.

55. The buoyancy system according to claim 40 wherein the deployment means delays the inflation of the at least one body to ensure the at least one body does not inflate until the aircraft is in the water.

56. The buoyancy system according to claim 40 comprising a release means so that the buoyancy system can be detached/jettisoned from the aircraft.

57. The buoyancy system according to claim 56 wherein the release means is operated if the aircraft buoyancy system is unintentionally activated.

58. The buoyancy system according to claim 40 wherein the aircraft buoyancy system is configured to be easily attached and detached from the aircraft.

59. The buoyancy system according to claim 40 wherein the buoyancy system is powered by its own independent power source or from a power source within the aircraft, or a combination of both

60. A buoyancy system adapted to be fitted to a helicopter for keeping the helicopter afloat and in a favourable orientation for escape, upon crashing or ditching into a body of water, the system comprises:
at least one inflatable body which, when inflated, increases the buoyancy of the helicopter, the at least one inflatable body being positioned on the helicopter such that once inflated the helicopter is maintained in a favourable orientation for escape once inflated the at least one inflatable body being in proximity to the centre of gravity of the helicopter;
an inflation apparatus to inflate the at least one inflatable body;
a sensor and activation system to activate the inflation apparatus where upon meeting crash activation criteria, the sensor and activation system will activate the inflation apparatus causing a gas to be supplied to the at least one inflatable body, which once inflated to the required volume enables the helicopter to remain positively buoyant at the surface of a body of water;
a deployment device, the deployment device restricting the inflation of the at least one inflatable body until the blades of the helicopter have detached from the helicopter or otherwise stopped rotating.

61. An aircraft having at least one buoyancy system according to claim 40 fitted thereto.
